(19) United States
(12) Patent Application Publication
(10) Pub. No.: US 2009/0220729 A1
(43) Pub. Date: Sep. 3, 2009

(54) Needle-Punched Glass Mat

(76) Inventors: Francois Roederer, Chambery (FR); Emilio Bassani, Milano (IT)

Correspondence Address: OWENS CORNING, 2790 COLUMBUS ROAD, GRANVILLE, OH, 43023, US

(21) Appl. No.: 12/294,295

(22) PCT Filed: Mar. 20, 2005
(86) PCT No.: PCT/FR2007/050968

§ 371 Date: May 8, 2009

(30) Foreign Application Priority Data
Mar. 24, 2006 (FR) 0651034

(51) Int. Cl. B32B 3/02; B29C 45/00; C08L 39/06; D04H 13/00

(52) U.S. Cl. 428/102; 264/328.1; 524/548; 156/148

(57) ABSTRACT

The invention relates to a mat made of needle-punched strands comprising a strand made of mineral glass that has been sized by a composition comprising water, where the solids content of said composition comprises 1-30 wt % coupling agent and 30-99 wt % polyvinylpyrrolidone. The invention also relates to a method for the preparation of a mat comprising
a) the deposition or projection of sized strands onto a moving belt to form a blanket of said strands, which is driven by said belt, then
b) the needle punching with barbed needles which pass through said blanket and move in the direction of the blanket at substantially the same speed as the blanket when they pass through it, with a punch density ranging from 1 to 25 punches per cm².

This method is rapid and effective, and the mat obtained can be deformed easily by hand to be placed in a mold for the manufacture of a composite by the injection of resin (RTM), This mat can also be incorporated into a sheet of preimpregnated material (SMC) and be molded under pressure.

The invention relates to a novel mat of glass fibers that is usable for the reinforcement of composite materials prepared notably by injection (so-called RTM method from the English “resin transfer molding”) or prepared from a sheet molding compound (synonymous with SMC from the English sheet molding compound). One can also impregnate the mat according to the invention directly with a thermosetting resin, notably to prepare translucent plates, The RTM method and the method using sheet molding compound generally use thermosetting matrixes. However, it is not ruled out to use the mat according to the invention in the context of the preparation of a composite with thermoplastic matrix, especially of the polyurethane type, notably via the RIM method (from the English “reinforced injection molding”).

Owing to the invention, the compounds prepared are particularly translucent, and one distinguishes no or only a few strands by transparency in the composite.

A mat for the reinforcement of composite materials must present preferably the following properties:
sufficient cohesion to be windable, unwindable (storage and transport),
sufficient cohesion to be cut into pieces, be held by hand, and placed by hand into the mold (RTM),
not prick the hands when one handles it or places it into the mold (RTM),
allow itself to be deformed easily by hand, when one places it manually in the mold (RTM),
correctly preserve the shape that is imparted by hand in the mold (RTM),
allow itself to be impregnated by the injection resin (RTM) or SMC (generally of the polyester type and sometimes of the epoxy type) in the easiest possible way,
present a structure that is as homogeneous as possible, particularly without holes or another surface feature that can cause a mark on the surface of the final product,
reinforce the composite as much as possible.

In addition, one wishes to manufacture it
at the greatest possible speed,
with the fewest possible steps, and
using the fewest possible chemical products (such as the binders).

The final composite must present generally the best possible resistance to impacts, the least possible uncontrolled porosity (no unintentionally enclosed gas bubbles), and the best possible surface appearance, notably the exposed edge (narrow face) of the final pieces, and it must be as transparent as possible.

WO2005/054559 teaches a method for the preparation of a mat that comprises

a) the deposition or projection of fibers on an advancing moving belt to form a blanket of said fibers, which is driven by the belt, then

b) the needle punching with barbed needles that pass through said blanket and move in the direction of the blanket at substantially the same speed as the blanket when they pass through it, with a punch density ranging from 1 to 25 punches per cm².

This method leads to mats of excellent quality for the reinforcement of composite materials. However, the applicant has discovered that the nature of the sizing could influence the behavior of the mat during the needle punching. While a standard sizing of mineral fibers (notably of glass) can result in the breaking of the strands during the needle punching, the sizing according to the invention protects the fibers much better during needle punching, and it confers to the strand a better flexibility and a more sliding surface, and much fewer strand ruptures have to be deplored. The breaking of the strand during the needle punching results in the release of airborne particles into the manufacturing workshop, discomfort during handling (it pricks the hands), and in the fact that the mat presents a less satisfactory resistance. In addition, the reinforcing strength for the composite is reduced.

The present invention procures an improvement of the teaching of WO2005/054559 whose content is included by reference. The technique of deposition of continuous strands in a blanket on a flat conveyor has been described notably in U.S. Pat. No. 3,969,171 and U.S. Pat. No. 4,208,000. Notably, the sizing of the glass strands has the function of facilitating the handling of said strands by these devices. Particularly, the sizing protects the strands from breaking and it promotes the adherence of the strand to the wheels of these devices. This adherence must be neither too strong nor too weak. The strand must not slide too much, so that one can optimize its tension between the wheels of these devices (such as the one of FIG. 4 of U.S. Pat. No. 3,936,558).

Sizing compositions containing a small quantity of polyvinylpyrrolidone have been taught by FR2349622, U.S. Pat. No. 4,140,833, FR2413336, U.S. Pat. No. 5,038,555, U.S. Pat. No. 4,448,911, WO2005/012201.

The invention concerns first a mat of glass strands that have been sized by a composition comprising water and whose solids content comprises 1-30 wt % coupling agent and 30-99 wt % polyvinylpyrrolidone (PVP). According to the invention, one sizes the mineral strands, (notably glass strands) with this sizing composition. The solids content of the composition can also comprise, in addition, 0-79 wt % lubricant (non PVP), preferably 5-70 wt % lubricant, and even more preferably 20-70 wt % lubricant.

Notably, the coupling agent can be present in the solids content in the amount of 2-10 wt %. The PVP can especially be present in the amount of 30-90 wt %. Notably, the lubricant (not of the PVP type) can be present in the amount of 5-78 wt %.

In general, the composition (which can be used as a sizing composition) contains no epoxy resin.

The coupling agent is usually an organosilane whose function is to improve the binding between the fibers and the matrix of the composite. Thus, it should be chosen as a function of the matrix (which is generally of the thermosetting type).

This organosilane also comprises at least one reactive group capable of reacting with the surface hydroxyl groups of the mineral fibers (made notably of glass) in such a way as to graft the modified organosilane (which is modified in that it has reacted with its reactive group and has thus lost a part of said reactive group) to the surface of the filaments. The organosilane that is used during the sizing is generally the hydrolyzed derivative of an alkylsilane, itself comprising generally the trialkoxysilane group, i.e., —Si(OR)₃, where R represents a hydrocarbon radical, such as a methyl or ethyl or propyl or butyl radical. The organosilane can thus be, for example, the hydrolyzed derivative of one of the following compounds:
gamma-aminopropyltriethoxysilane
gamma-glycydoxypropyltrimethoxysilane
methacryloxypropyltrimethoxysilane (often referred to as A174).

Polyvinylpyrrolidone can have a weight-average molecular weight of 6000-3,000,000, preferably 100,000-2,000,000.

The lubricant is oily to the touch. The lubricant can be chosen notably from the following list:
cocotrimethylammonium chloride
lithium chloride
quaternary cationic ammonium salt
alkylphenolethoxylated ester (notably the Stantex FT 504 from Cognis)
Arquad C35 (for example, Akzo Nobel).

The lubricant is preferably a polyethylene ester glycol (often called PEG). Notably, it can be PEG 400 mL.

The sizing composition preferably contains, in addition, an antifoaming agent, whose content in the solids content can be 5-500 ppm by weight.

The sizing composition contains water. The quantity of water is such that the solids content of the composition represents 0.5-10 wt %, and preferably 0.8-6 wt % of the composition. The applicant has discovered notably that the content in the solids content of the sizing composition can be very low, for example, on the order of 0.8-2 wt %, which presents the advantage of causing less soiling of the operating devices.

The use of continuous strands leads to an advantage at the level of the surface appearance and more particularly the exposed edge of the final composites, and at the level of the homogeneity of the distribution of the fibers in the final composite. Indeed, the exposed edge of the molded pieces is much more distinct, smooth and better shaped than when cut strands are used. It seems that the use of cut strands requires that a large quantity of the ends of cut strands be located on the surface or just below the surface of the exposed edges of pieces. The origin of this phenomenon is the fact that the cut strands naturally have an orientation parallel to the principal faces of the composite. This accumulation of ends of cut strands at the exposed edges seems to promote the presence of porosities at the exposed edges at the beginning of the process. The bubbles formed then dilate due to the effect of the temperature (on the order of 200° C. for the solidification of the thermosetting resin), which tends to deform the appearance of the surface of the exposed edges. It seems that the use of continuous strands reduces this phenomenon considerably. Indeed, instead of a strand end at the surface (when cut strands used), one would get more of a loop of continuous strand, which goes toward a smoother surface.

For the SMC application, the mat must in addition be able to creep easily during molding under a press. We recall that an SMC, prior to molding, is in the form of a prepreg sheet containing a thermosetting resin, where said sheet contains in its middle a blanket of reinforcement strands. According to the prior art, these strands are systematically cut strands. Indeed, in the mold, the SMC is subjected to a pressure and it must creep easily to fill the entire volume of the mold due to the effect of the pressure. For the person skilled in the art, this creep is possible because the strands are cut and can move easily with respect to each other. The SMC surface before pressing in general represents only approximately 30% of the surface of the final composite. There is a change from 30% to 100% due to the effect of the compression. According to the prior art, to prepare an SMC, one projects cut strands on a moving blanket of a resin-based paste, and one deposits another blanket of paste on top to enclose the cut strands, as in a sandwich. The SMC is then wound and stored. It is unwound to cut off a piece (generally called “flap of prepreg material”) whose surface represents only 30% of the surface area of the final piece, one places said piece into a mold, and one proceeds to hot molding under the press. The thermosetting resin hardens during this treatment. In the context of the present invention, one can use, instead of cut strands, continuous strands in the context of the SMC technology. Indeed, the blanket of continuous strands can creep sufficiently during the compression of the SMC. One can use the mat strands according to the invention (cut or continuous strands) in the context of the SMC technique. The use of continuous strands of SMC additionally leads to an advantage at the level of the surfaces, and particularly of the exposed edges of the final composites. Indeed, the exposed edge of the molded pieces is much more distinct, smooth and better-shaped than when cut strands are used. In addition, when cut strands are used, the required creep of the SMC during the molding leads to a preferential orientation of the strands, which can generate surface corrugations. Indeed, since the cut strands are independent, they follow the flows too easily and orient themselves along the lines of flow. The strands can even agglomerate or form clumps as a result of following these flows too much. On the other hand, the continuous strands resist any orientation because of their length, while sufficiently following the expansion of the SMC during the compression. Consequently, the use of continuous strands leads to a better homogeneity of the reinforcement of the composite. At an identical fiber content, the use of a continuous strand generally leads to a composite having a superior rigidity that is 5-12% better in comparison to the use of a cut strand.

The manufacture of a mat for the reinforcement of the composites by the RTM method generally passes through the step of deposition or projection of freshly sized strands on a moving belt. However, the bed of strands at this stage has no consistency and cannot be handled. It can also not be wound or unwound, because its different layers of strands would mix. Therefore, it must be bound either chemically or mechanically.

For chemical binding, one applies a chemical binder of the thermoplastic or thermosetting type to it, generally in powder form, and one then proceeds to a thermal treatment, which melts the thermoplastic or polymerizes the thermosetting product, and finally, after cooling, creates bridges between the strands. However, this binder confers a springiness effect to the structure of the mat, which then tends not to keep less gradual shapes (for example, in the corners of the mold). On the other hand, there is a desire to limit the use of chemical products in the spirit of respecting the environment. In addition, the melting heat treatment of the thermoplastic is at a relatively high temperature (220-250° C.), which leads to a severe baking of the sizing, making the strands and thus the mat more stiff and more difficult to deform (the glass lattice is then blocked).

To provide mechanical binding for a mat, the latter can be subjected to a conventional needle punching. However, this generally leads to the breaking of strands, causing a lowering of the mechanical properties, as well as to the formation of points that emerge from at least one face of the mat. These points then prick the hands of the handlers. In addition, since the mat advances while the needles planted in the mat are fixed horizontally and move only vertically, this causes perforations much larger than the cross sections of the needles, and tends to twist the needles. These perforations mark the surface, which is reflected in surface defects in the final piece. Indeed, these holes fill with resin, and because of the shrinkage of the resin after polymerization, depressions remain visible on the surface.

Known mats exist which comprise a central core made of curly fibers of polypropylene (PP) and of external layers of cut glass strands, all of which are bound by a seam of synthetic wire, such as polyester (PET). The curly fiber tends to give body to the mat, to facilitate the penetration of the resin and fill the gap of the mold (space between the two metal parts of the mold). However, neither the PET nor the PP fiber reinforces the composite. In addition, the seam is visible in the final composite, and, moreover, the needles used for the seam cause holes at the surface. These holes fill with resin and, because of the shrinkage of the resin after polymerization, depressions remain visible on the surface.

According to the invention, one applies a special needle punching to the mat, giving it sufficient consistency, without breaking or while breaking only few strands, notably because of its special sizing, and without formation of any excessively large holes. The mat according to the invention is sufficiently deformable by hand at ambient temperature and it is very permeable to the resin. According to the invention, the needle punching is achieved with needles that move at the same time as the mat, at substantially the same speed as the mat, in a direction parallel to the direction of displacement of the mat. In addition, the number of needle punches is reduced; it is at most 25 punches per cm², preferably at most 15 punches per cm², and even more preferably at most 10 punches per cm². In general, the number of needle punches is at least 1 punch per cm² and preferably at least 2 punches per cm².

We recall that mats and felts differ clearly to the extent that a mat is a flat object that can be used as reinforcement, while a felt is an object that has volume and can be used for thermal insulation. The mat generally has a thickness of 0.8-5 mm, and more generally 1-3 mm, while a felt is much thicker, having generally a thickness of more than 1 cm. A felt usually has a density of 85-130 kg/m³. A mat is much more dense, since its density can be on the order of 300 kg/m³. However, one does not express the density of a mat in terms of volume-based density, but in surface area-based density, as a flat reinforcement.

Thus, the invention relates notably to a method for the preparation of a mat comprising

a) the deposition or projection of fibers on an advancing moving belt to form a blanket of said fibers, which is driven by the belt, then

b) the needle punching with barbed needles that pass through said blanket and move in the direction of the blanket at substantially the same speed as the blanket when they pass through it, with a punch density ranging from 1 to 25 punches per cm².

It is preferred for at least 1 barb and preferably 2 barbs of each needle to pass though the thickness of the mat at each punch. It is preferred for the depth of penetration of the needles (length of needle sticking out of the mat after having passed through it) to be 5-20 mm. The needles preferably have a diameter (smallest circle that contains the entire cross section of the needle including the barbs) of 0.2-3 mm, and even more preferably of 0.5-1.5 mm. Such needle punching leads to a mat that can be handled, wound and unwound, and easily removed manually from the mold, and that does not prick the hand, and presents no hole marks on the surface. Due to this special needle punching, one can cause the mat to advance at high speeds, for example, at at least 2 m per min, and even at least 5 m per min, and even at least 8 m per min. In general, the speed is at most 35 or at most 30 m per min, or at most 20 m per min. During the passage of the needles through the mat, strands become set in the barbs and they are entrained to form loops in front of the mat, without rupturing the strands. These loops link the mat and can easily be deformed while preserving the function of binder during placement in the mold. These loops do not prick the hands because there is no rupture of the strands.

To achieve such needle punching, one can, for example, use certain preliminary needle punching devices with a cylinder, which are normally designed to process felts made of polymer fibers, such as, for example, the machine with part number PA169 or PA1500 or PA2000 marketed by Asselin (NSC group). In this type of machine, the needles describe an elliptic movement with a horizontal component that allows the needles in the mat to follow it in its movement.

The mat according to the invention has generally a surface area-based density of 50-3000 g/m². It may be a mat with cut strands or a mat with continuous strands. Thus, before the needle punching, one deposits or projects on the moving belt that advances in the direction of the needle punching device, cut strands having generally a length of 10-600 mm, and more particularly 12-100 mm, or continuous strands. In the case of continuous strands, whose number may be 5-1200, they are projected on the moving belt through the intermediary of an arm that oscillates transversely with respect to the direction of advance of the belt. For the technique of projection of continuous strands, reference can be made, for example, to WO 02084005. Each of the projected strands can comprise 20-500 unit fibers (in fact, continuous filaments). It is preferred for the strand to have a titer of 12.5-100 tex (g/km).

The material constituting the fibers (continuous filaments), and thus the strands, is mineral, and can comprise a friable glass, such as glass E or the glass described in FR2768144 or an alkaline-resistant glass called AR glass, which comprises at least 5 mol % ZrO₂. Notably, the use of the glass AR leads to a mat that reinforces effectively matrices made of cement or can reinforce thermosetting composites with matrix, which are to come in contact with the corrosive environment. The glass can also be free of boron. Moreover, one can also use a mixture of glass fibers and polymer fibers, such as polypropylene fibers, notably the mixed fibers marketed under the trademark Twintex® by Saint-Gobain Vetrotex France. The strands used to produce the mat thus comprise glass fibers (filaments).

The invention also relates to a method for manufacturing a mat, which method comprises the already described needle punching step. Before needle punching, the cut or continuous strands are deposited or projected onto a moving belt. At this stage, the strands can be dry, either because they come from rovings (or bobbins), or because they were dried after sizing and before the needle punching according to the invention. However, the applicant has observed that it is advantageous for the strands to be slightly humid to pass into the needle punching device. Excessively high humidity can lead to soiling.

The mat according to the invention may be subjected to at least one drying step, depending on the case. If the strands used are dry at the start, and the strands are not impregnated with any liquid, the drying is not necessary. The drying is necessary if the strands are impregnated with a liquid at the time of the manufacture of the mat according to the invention. In general, the strands are freshly sized at the time of their use in the method according to the invention. Thus, it is possible to dry the strands on the moving belt before the needle punching. However, as already indicated, it is preferred to preserve the impregnated state for the needle punching, and thus it is preferred to dry the sheet of strands only after the needle punching. The drying can be carried out by passing the moving belt into an oven at a temperature of 40-170° C., and more particularly 50-150° C. Such a thermal treatment does not produce an excessively strong drying of the sizing of the strands, which preserve flexibility intact.

The mat according to the invention can be integrated in a complex comprising several juxtaposed layers. Notably, the mat according to the invention, in its variant using continuous strands, can constitute the layer with randomly distributed continuous strands of the fibrous structure that is the object of WO 03/060218, whose text is incorporated in the present document by reference. More particularly, the mat according to the invention can be incorporated into a multilayer complex having the following structure: mat according to the invention+layer of strands cut on one side of the mat according to the invention or mat according to the invention+layer of cut strands on the two sides of said mat (complexes with 2 or 3 layers). Thus it is possible to deposit onto the moving belt a first layer of fibers (for example: strands cut, for example, to a length of 12-100 mm), and then deposit the strands on this layer to form the mat according to the invention, to proceed to the needle punching according to the invention and thus link the two layers to each other by needle punching. One can also add a third layer (for example: strands cut, for example, to a length of 12-100 mm) before the needle punching according to the invention.

At the end of the manufacture of the mat, one can optionally proceed to a cutting of the edges of the ribbon of mat formed, because the edges may present a structure or density that is slightly different from the central part.

One would remain within the scope of the invention if one were to proceed in one of the following ways:

a) by binding the fibers of the mat with a water-soluble binder (example: a polyvinyl alcohol) before the needle punching and then removing the binder by dissolution in the water or in an aqueous solution before the needle punching;

b) by binding the fibers of the mat with a water-soluble binder (example: a polyvinyl alcohol) before the needle punching, and then removing the binder by dissolution in water or in an aqueous solution after the binding;

c) by depositing or projecting the strands onto the film which itself rests on a moving belt, and then winding the unbound blanket of strands at the same time as the film (where the latter prevents the different wound layers from mixing), for a possible intermediate storage, and then unwinding the bilayer film/blanket by removing the film and placing the blanket back on a moving belt for the continuation of the method according to the invention.

The mat obtained by the method according to the invention contains no binder. It is symmetric with respect to a parallel plane and passes through its middle. It has sufficient cohesion to be wound into roll form and be unwound for use.

The invention leads notably to a needle-punched mat of continuous strands or cut strands (preferably continuous strands) consisting of mineral fiber (notably glass) that is optionally sized, and presenting no needle hole that is visible to the naked eye. This mat thus contains a maximum of mineral fiber to reinforce the composite as much as possible, in the absence of polymer-based synthetic materials (PP, polyester, etc.) that are not reinforcing for the composite, except for possible organic components of the sizing of the fibers. This mat is used advantageously to reinforce a composite in the closed-mold injection method (RTM) or in the context of the SMC technology, or to be impregnated directly with resin to make plates, particularly translucent plates.

The mat obtained by the method according to the invention can be integrated in a prepreg sheet (SMC). The mat according to the invention is then inserted continuously between two layers of thermosetting resin paste. One unwinds and then integrates slowly said mat between two layers of resin paste. In addition to the mat according to the invention, it is not ruled out to add other reinforcement layers in the SMC, such as, for example, cut strands, notably glass strands. For example, one can proceed as follows:
horizontal unwinding of the mat according to the invention on a layer of resin paste, then
projection onto the mat of cut strands, then
unwinding of the layer of resin paste onto the cut strands.

One can also place a layer of cut strands before unwinding the mat according to the invention.

The SMC sheet can serve for the manufacture of a composite material by molding the sheet via pressure on its principal faces, which leads to a widening of the sheet in the mold before the solidification of the resin. In the case where the mat has continuous strands, the cut SMC sheet has, before molding under pressure, preferably a surface representing 50-80% of the surface area of the mold (and thus of the surface area of the final piece).

The fact that one does not use any chemical binder to produce the mat according to the invention makes it possible to produce particularly translucent composites. The applicant has indeed observed that the absence of binder notably improved the translucence of the final composite. To produce such translucent composites, one can notably use the method represented in FIG. 4 of WO2005/054559.

The solids content of a composition can be determined by evaporation in an oven at 110° C. for 12 h. Pure PVP has a solids content of 100% PEG 400 mL has a solids content of 100%. For the person skilled in the art, in the case of silane, the reference is naturally to what remains of the silane after the hydrolysis, and after evaporation of the water. The person skilled in the art also uses the term active matter. A174 silane has a solids content of 82 wt %. Starting with 10 g of unhydrolyzed silane, after hydrolyzing it and treating the hydrolysate in the oven at 110° C. for 12 h, one finally collects 8.2 g of solids content. When one says that the solids content of a sizing composition comprises 1-30% coupling agent, the person skilled in the art understands immediately that this solids content does not contain exactly the product as supplied by the manufacturer, but that it is a hydrolyzed residue of this product, which has then been dehydrated. Thus, one could say equivalently that the solids content of the composition comprises 1-30 wt % originating from a coupling agent.

### EXAMPLES 1-5

In the following example, sizings according to the invention are compared to a conventional sizing and to a sizing without PVP.

The conventional sizing (for Example 1) contained in its solids content (the latter representing 4% of the sizing composition):
5 wt % A174 silane
91 wt % Neoxyl film former
3.9 wt % Antarox lubricant.

The other sizing composition contained 1.3 wt % solids content, the latter itself comprising 6.4 wt % of A174 silane and 50 ppm by weight of an antifoaming agent (of trademark Agitan 295 marketed by Munzing Chemie). The other ingredients of this solids content are indicated in the second column of Table 1, and they are either PVP with a weight-average molecular weight of 900,000, or PEG 400 mL, or a mixture as indicated of these two components. Thus, PVP 100% indicates that the rest of the solids content, excluding silane and the antifoaming agent, consists of 100% PVP.

Using the continuous glass strand sized with these compositions, one prepares mats with continuous strands by projection in a blanket on a moving belt. The projection was carried out using a device based on the principle of FIG. 4 of U.S. Pat. No. 3,969,171. The needle punching was carried out according to FIG. 3 of WO2005/054559, with a punch density of 3 punches per cm².

Composites were then produced by impregnation of the different mats with the help of a thermosetting resin and according to the RTM procedure.

Table 1 below collects the results. A comparison is made between the different sizings with regard to the behavior of the strand or of the mat during different steps of the method, as well as to the level of quality of the final composite. These are relative evaluations This behavior was ranked −− (minimum rank) and ++ (maximum rank). The following behaviors were observed:
the behavior during the deposition of the continuous strand in a blanket: in the case of Example 3, the deposition was difficult, because the strand slipped too much on the wheels of the projection device, so that the drawing of the fill was difficult to control;
the behavior during the needle punching: two defects were observed, breaking of strands in the case of Example 1, and impossibility of needle punching in the case of Example 3; in the latter case, the strand turned out to be too slippery, and the strand returned too frequently when the needles came out of the mat, which is equivalent to the near absence of needle punching and the reason that the mat did not present sufficient resistance;
the deformability by hand in the impregnation mold: it is acceptable for all the examples; however, it is slightly inferior in the case of Example 2;
the translucence of the final product.

| | | \textcircled{3} | | | \textcircled{6} |
|---|---|---|---|---|---|
| \textcircled{1} | | Dépose | | \textcircled{5} | Translucidité |
| Ex | \textcircled{2} | en | \textcircled{4} | Déformabilité | Composite |
| n° | ensimage | nappe | Aiguilletage | à la main | final |
| 1 | \textcircled{7} | + + | − − | − | − |
| | classique | | \textcircled{8} | | |
| | | | (cassures) | | |
| 2 | PVP: 100% | + + | + + | + | + + |
| 3 | PEG: 100% | − | − − | + + | |
| | | | \textcircled{9} | | |
| | | | (ne tient | | |
| | | | pas) | | |
| 4 | PVP/PEG: | + + | + + | + + | + + |
| | 50/50 | | | | |
| 5 | PVP/PEG: | + + | + + | + + | + + |
| | 75/25 | | | | |

Key: \textcircled{1} Example No.
\textcircled{2} Sizing
\textcircled{3} Deposition in a blanket
\textcircled{4} Needle punching
\textcircled{5} Deformability by hand
\textcircled{6} Translucence Final composite
\textcircled{7} (conventional)
\textcircled{8} (breaks)
\textcircled{9} (does not hold)

1. Mat made of needle-punched strands comprising a strand made of mineral glass that has been sized with a composition comprising water, where the solids content of said composition comprises 1-30 wt % coupling agent and 30-99 wt % polyvinylpyrrolidone.

2. Mat according to the preceding claim, characterized in that the strands are continuous.

3. Mat according to one of the preceding claims, characterized in that the solids content of said composition comprises 2-10 wt % coupling agent.

4. Mat according to one of the preceding claims, characterized in that the solids content of said composition comprises 30-90 wt % polyvinylpyrrolidone.

5. Composition according to any one of the preceding claims, characterized in that its solids content comprises a lubricant content of less than 79 wt %.

6. Composition according to the preceding claim, characterized in that the lubricant content is 5-70% in the solids content.

7. Mat according to the preceding claim, characterized in that the lubricant content is 20-70% in the solids content.

8. Mat according to one of the preceding claims, characterized in that the solids content of said composition comprises 5-500 ppm by weight of antifoaming agent.

9. Mat according to one of the preceding claims, characterized in that said composition contains no epoxy resin.

10. Mat according to one of the preceding claims, characterized in that the solids content of said composition represents 0.5-10 wt % of said composition.

11. Mat according to the preceding claim, characterized in that the solids content of said composition represents 0.8-6 wt % of said composition.

12. Mat according to the preceding claim, characterized in that the solids content of said composition represents 0.8-2 wt % of said composition.

13. Mat according to one of the preceding claims, in the form of a roll.

14. Method for the preparation of a mat of one of the preceding claims comprising
a) the deposition or projection of strands of mineral glass that are sized by the composition onto a moving belt to form a blanket of said strands, which is driven by said belt, then
b) the needle punching with barbed needles that pass through said blanket and move in the direction of the blanket at substantially the same speed as the blanket when they pass through it, with a punch density ranging from 1 to 25 punches per cm².

15. Method for the preparation of a composite material with thermosetting matrix comprising the impregnation of a mat of one of the preceding mat claims with a thermosetting resin.

16. Method according to the preceding claim, characterized in that it is a method with injection into a closed mold (RTM).

17. Method for the preparation of a prepreg sheet (SMC) comprising the continuous insertion of a mat of one of the preceding mat claims between two layers of thermosetting resin paste.

18. Prepreg sheet comprising a mat of one of the preceding mat claims and a thermosetting resin.

19. Method for the manufacture of a composite material by molding the sheet of the preceding claim by pressure on its principal faces leading to a widening of the sheet before solidification of the resin.

20. Composite material with thermosetting matrix, reinforced by a mat of one of the preceding mat claims.
